(19) United States
(12) Patent Application Publication
(10) Pub. No.: US 2022/0253166 A1
(43) Pub. Date: Aug. 11, 2022

(54) DOUBLE-SIDED TOUCH PANEL AND MANUFACTURING METHOD THEREOF

(71) Applicant: HANNSTOUCH SOLUTION INCORPORATED, Tainan (TW)

(72) Inventor: Sheng-Chia Lin, Tainan (TW)

(21) Appl. No.: 17/168,566

(22) Filed: Feb. 5, 2021

(51) Int. Cl. G06F 3/041; G06F 3/044

(52) U.S. Cl. CPC G06F 3/0412; G06F 3/0446; G06F 3/0443; G06F 2203/04111; G06F 2203/04107; G06F 2203/04103; G06F 2203/04112

(57) ABSTRACT

A double-sided touch panel is disclosed. The proposed double-sided touch panel includes a first substrate, a first touch layer having plural pairs of interlaced first sensing electrodes and second sensing electrodes, and configured on the first substrate, a display driver layer configured on the first touch layer and a second touch layer having plural pairs of interlaced third sensing electrodes and fourth sensing electrodes, and configured on the display driver layer.

### FIELD OF THE INVENTION

The present invention relates to a double-sided touch panel and a manufacturing method thereof, in particular to a double-sided touch panel having two touch layers and a manufacturing method thereof.

### BACKGROUND OF THE INVENTION

Currently, cell phones and tablets that have touch panels are all using single-sided touch panels. However, following the development of the next generation of display technology, the techniques of double-sided touch panels will be used to facilitate the user to engage in a touch operation and/or input information through one of a front screen and a rear screen opposite to each other. That will be convenient to use and also more effective.

Given consideration to both the functionality of the double-sided touch panel and the convenience, a novel design must be provided.

### SUMMARY OF THE INVENTION

It is the aim of the present invention to provide a double-sided touch panel having a first touch layer with plural pairs of interlaced first sensing electrodes and second sensing electrodes and configured on a first substrate, a second touch layer with plural pairs of interlaced third sensing electrodes and fourth sensing electrodes and configured on a display screen or embedded in the display screen, and a second substrate. The first and the second substrates are transparent cover plates or translucent cover plates. The proposed manufacturing method of the double-sided touch panel manufactures the elements of the first touch layer at the same time when the display is manufactured to solve the existing problems of the follow-up bonding required by the double-sided touch panel, and the overall thickness of the double-sided touch panel will be decreased.

In accordance with the first aspect of the present invention, a double-sided touch panel comprises a first substrate, a first touch layer having plural pairs of interlaced first sensing electrodes and second sensing electrodes, and configured on the first substrate, a display driver layer configured on the first touch layer, and a second touch layer having plural pairs of interlaced third sensing electrodes and fourth sensing electrodes, and configured on the display driver layer.

In accordance with the second aspect of the present invention, a method of manufacturing a double-sided touch panel comprises steps of: (a) providing a first substrate; (b) configuring a first touch layer on the first substrate, wherein the first touch layer has plural pairs of interlaced first sensing electrodes and second sensing electrodes; (c) configuring a display driver layer to cause one side thereof to be adjacent to the first touch layer; (d) providing a second substrate; (e) configuring a second touch layer on the second substrate, wherein the second touch layer has plural pairs of interlaced third sensing electrodes and fourth sensing electrodes; and (f) causing the other side of the display driver layer to be adjacent to the second touch layer, wherein a first group of the steps (a) to (c) and a second group of the steps (d) to (e) are performed simultaneously or sequentially.

In accordance with the third aspect of the present invention, a method of manufacturing a double-sided touch panel comprises: providing a first substrate and a second substrate; configuring a first touch layer on the first substrate, wherein the first touch layer has plural pairs of interlaced first sensing electrodes and second sensing electrodes; configuring a display screen on the first touch layer; and configuring a second touch layer on the second substrate, or embedded in the display screen.

### BRIEF DESCRIPTION OF THE DRAWINGS

Other objectives, advantages and the efficacy of the present invention will be described in detail below taken from the preferred embodiments with reference to the accompanying drawings, in which:

FIG. 1(a) is a schematic diagram of a step 1(a ) of a method of manufacturing a double-sided touch panel according to the first preferred embodiment of the present invention.

FIG. 1(b) is a schematic diagram of a step 1(b) of a method of manufacturing a double-sided touch panel according to the first preferred embodiment of the present invention.

FIG. 1(c) is a schematic diagram of a step 1(c) of a method of manufacturing a double-sided touch panel according to the first preferred embodiment of the present invention.

FIG. 2(a) is a schematic diagram of a first preferred detailed structure corresponding to the first substrate, the first touch layer and the display driver layer in FIG. 1(a).

FIG. 2(b) is a schematic diagram of a second preferred detailed structure corresponding to the first substrate, the first touch layer and the display driver layer in FIG. 1(a).

FIG. 3 is a schematic structure diagram of a double-sided touch panel according to the first preferred embodiment of the present invention.

FIG. 4(a) is a schematic structure diagram of a double-sided touch panel according to the second preferred embodiment of the present invention.

FIG. 4(b) is a schematic structure diagram of a preferred detailed structure of a double-sided touch panel according to the second preferred embodiment of the present invention.

FIG. 5 is a schematic structure diagram of a double-sided touch panel according to the third preferred embodiment of the present invention.

FIG. 6 is a schematic structure diagram of a double-sided touch panel according to the fourth preferred embodiment of the present invention.

FIG. 7 is a schematic structure diagram of a double-sided touch panel according to the fifth preferred embodiment of the present invention.

FIG. 8(a) is a schematic structure diagram of a first touch layer of a double-sided touch panel according to the first to the fifth preferred embodiments of the present invention.

FIG. 8(b) is a schematic structure diagram of a second touch layer of a double-sided touch panel according to the first to the fifth preferred embodiments of the present invention.

### DETAILED DESCRIPTION OF THE PREFERRED EMBODIMENT

The present invention will now be described more specifically with reference to the following embodiments. It is to be noted that the following descriptions of the preferred embodiments of this invention are presented herein for purposes of illustration and description only; they are not intended to be exhaustive or to be limited to the precise form disclosed.

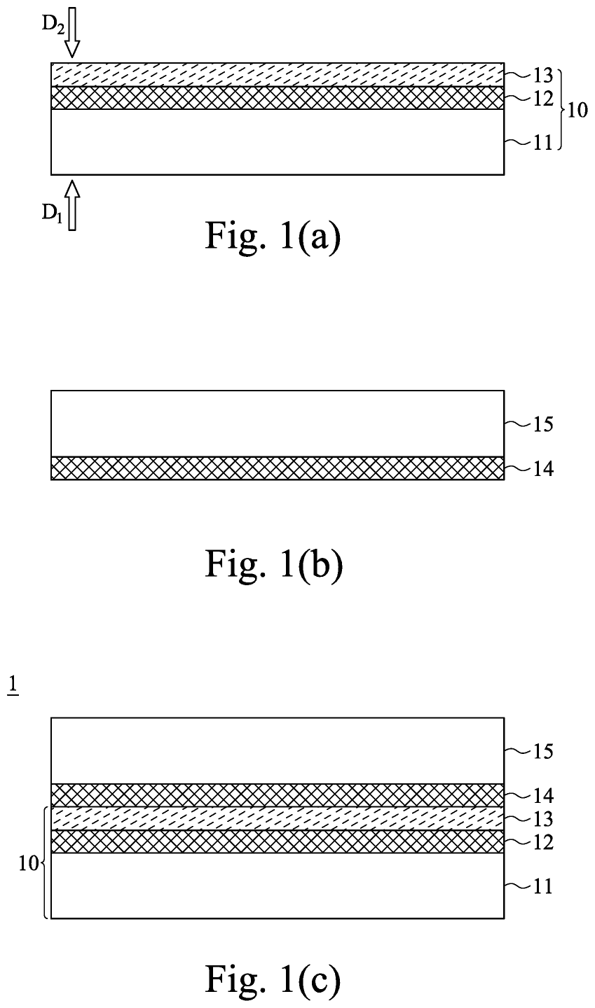

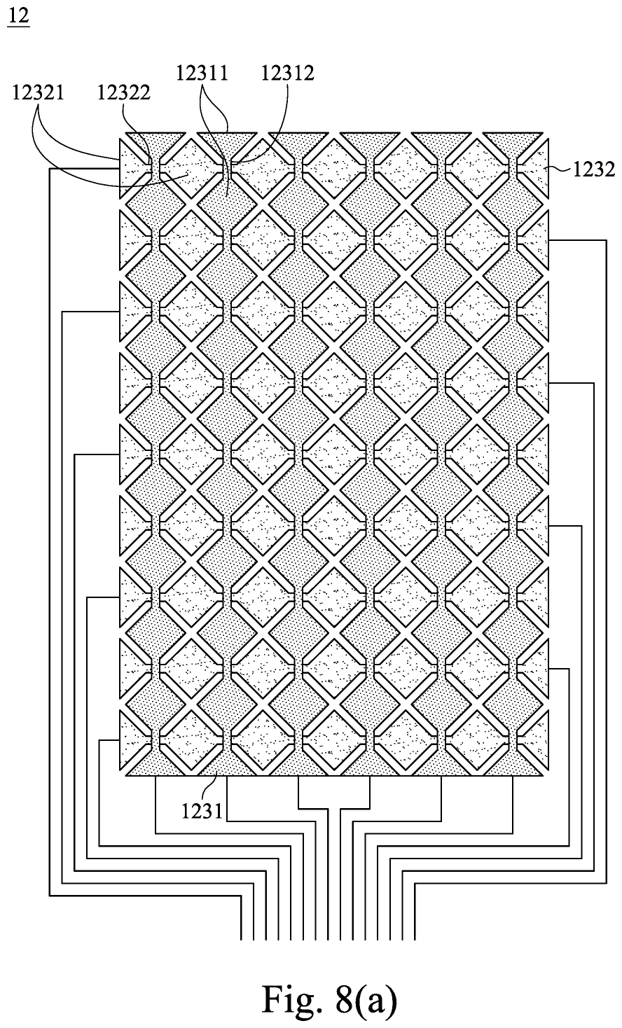

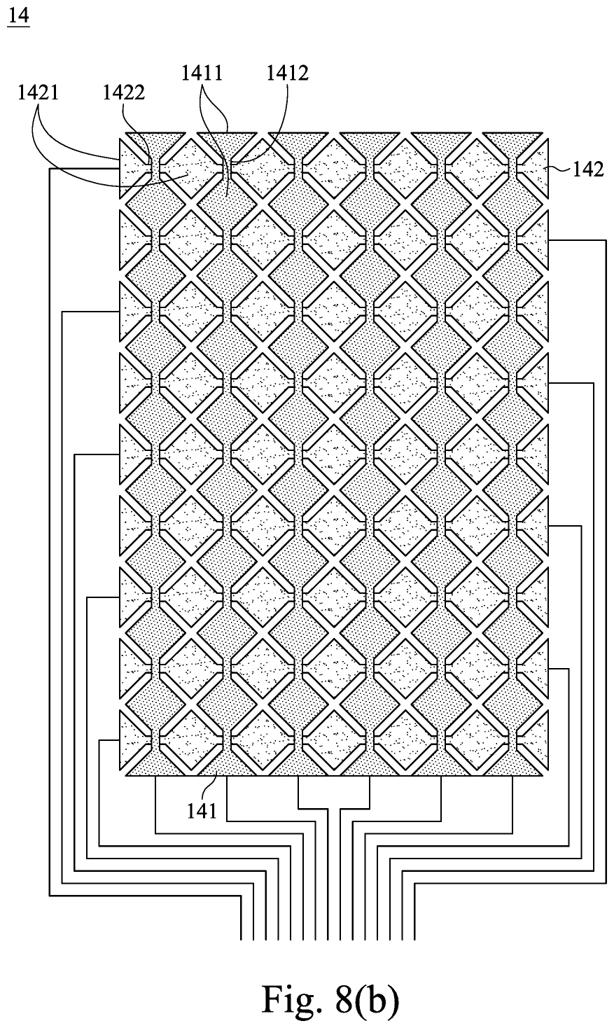

FIGS. 1(a) and 1(b) show schematic diagrams of a method of manufacturing a double-sided touch panel according to the first preferred embodiment of the present invention, wherein FIG. 1(a) is a schematic diagram of a step 1(a ) of the method of manufacturing the double-sided touch panel. In FIG. 1(a), a double-sided display 10 is mainly formed. As shown in FIG. 1(a), the screen displays can be seen from both a direction D₁ and a direction D₂. The double-sided display 10 can be any double-sided display, e.g., an AMOLED display, a PMOLED display, a Super AMOLED display, a Mini LED display, or a Micro LED display, and the double-sided display 10 does not rule out using the LCD technology and the electronic paper technology. The step 1(a ) includes: 1) providing a first substrate (a first cover plate) 11; 2) configuring a first touch layer 12 on the first substrate 11; and 3) configuring a display driver layer 13 on the first touch layer 12. As shown in FIG. 1(a), wherein the first substrate 11, the first touch layer 12 and the display driver layer 13 that together form a double-sided display 10, and the first touch layer 12 has plural pairs of interlaced first sensing electrodes 1231 and second sensing electrodes 1232 (refer to FIG. 8(a)), wherein the plural pairs of interlaced first sensing electrodes 1231 and second sensing electrodes 1232 form a first capacitive touch circuit.

Then, in FIG. 1(b), the step 1(b) is: configuring a second touch layer 14 on a second substrate (a second cover plate) 15, and the second touch layer 14 has plural pairs of interlaced third sensing electrodes 141 and fourth sensing electrodes 142 (refer to FIG. 8(b)), wherein the plural pairs of interlaced third sensing electrodes 141 and fourth sensing electrodes 142 form a second capacitive touch circuit.

FIG. 1(c) shows a schematic diagram of a step 1(c) of a method of manufacturing a double-sided touch panel according to the first preferred embodiment of the present invention. In FIG. 1(c), the step 1(c) includes: causing the double-sided display 10 to be combined with the second touch layer 14. The double-sided display 10 can be combined with the second touch layer 14 via an optical clear adhesive (not shown), but is not limited to that. When the step 1(c) is performed, a double-sided touch panel 1 is manufactured, and includes sequentially from the bottom to the top: a first substrate (a first cover plate) 11, a first touch layer 12, a display driver layer 13, a second touch layer 14 and a second substrate (a second cover plate) 15, wherein the first substrate 11 and the second substrate 15 are transparent cover plates or translucent cover plates, and the materials of which can be flexible materials or glass materials. The materials of the first touch layer 12 and the second touch layer 14 include metal meshes and/or transparent conductive materials, etc.

The step 1(a ) and the step 1(b) as shown in FIG. 1(a) and FIG. 1(b) can be performed simultaneously, and they may also be performed according to the sequence of: e.g., performing the step 1(a ) first, performing the step 1(b) next, and then performing the step 1(c); or performing the step 1(b) first, performing the step 1(a ) next, and then performing the step 1(c). The present invention proposes a method suitable for this type of execution and is listed as follows. A method of manufacturing a double-sided touch panel comprises: (a) providing a first substrate 11; (b) configuring a first touch layer 12 on the first substrate 11, wherein the first touch layer 12 has plural pairs of interlaced first sensing electrodes 1231 and second sensing electrodes 1232 (see FIG. 8(a)); (c) configuring a display driver layer 13 to cause one side thereof to be adjacent to the first touch layer 12; (d) providing a second substrate 15; (e) configuring a second touch layer 14 on the second substrate 15, wherein the second touch layer 14 has plural pairs of interlaced third sensing electrodes 141 and fourth sensing electrodes 142 (see FIG. 8(b)); and (f) causing the other side of the display driver layer 13 to be adjacent to the second touch layer 14, wherein a first group of the steps (a) to (c) and a second group of the steps (d) to (e) are performed simultaneously or sequentially.

Certainly, the above-mentioned double-sided touch panel 1 proposed by the present invention can also be manufactured sequentially following the order from the bottom to the top by a method different from the above-mentioned method. For example, a method of manufacturing a double-sided touch panel 1 comprises: providing a first substrate (cover plate) 11; configuring a first touch layer 12 on the first substrate 11, wherein the first touch layer 12 has plural pairs of interlaced first sensing electrodes 1231 and second sensing electrodes 1232 (see FIG. 8(a)); configuring a display driver layer 13 on the first touch layer 12; configuring a second touch layer 14 on the display driver layer 13, wherein the second touch layer 14 has plural pairs of interlaced third sensing electrodes 141 and fourth sensing electrodes 142 (see FIG. 8(b)); and configuring a second substrate (cover plate) 15 on the second touch layer 14.

Another method of manufacturing a double-sided touch panel 1 proposed by the present invention is listed below. A method of manufacturing a double-sided touch panel 1 comprises: providing a first substrate (cover plate) 11 and a second substrate (cover plate) 15; configuring a first touch layer 12 on the first substrate 11, wherein the first touch layer 12 has plural pairs of interlaced first sensing electrodes 1231 and second sensing electrodes 1232 (see FIG. 8(a)); configuring a display driver layer 13 on the first touch layer 12; configuring a second touch layer 14 on the second substrate 15, wherein the second touch layer 14 has plural pairs of interlaced third sensing electrodes 141 and fourth sensing electrodes 142 (see FIG. 8(b)), wherein the second substrate 15 is a flexible substrate; and causing the display driver layer 13 to be combined with the second touch layer 14.

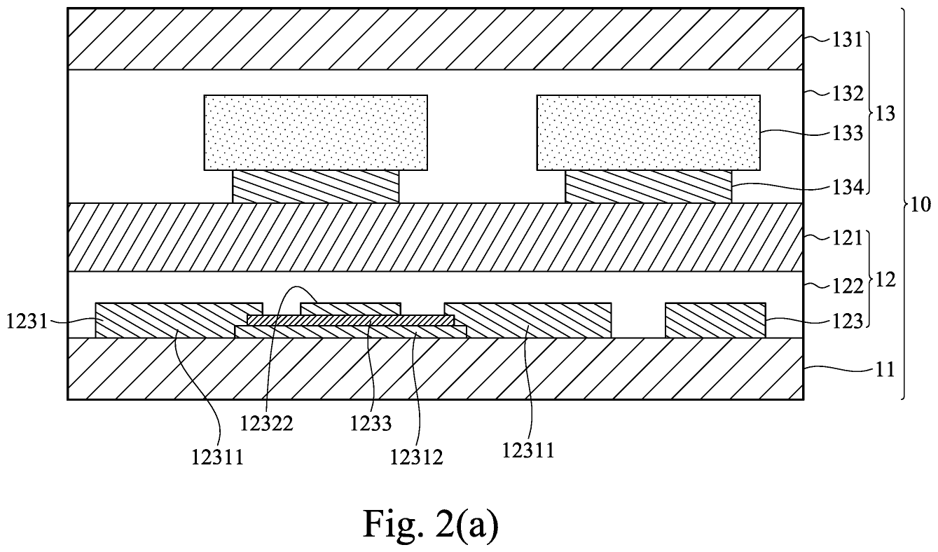

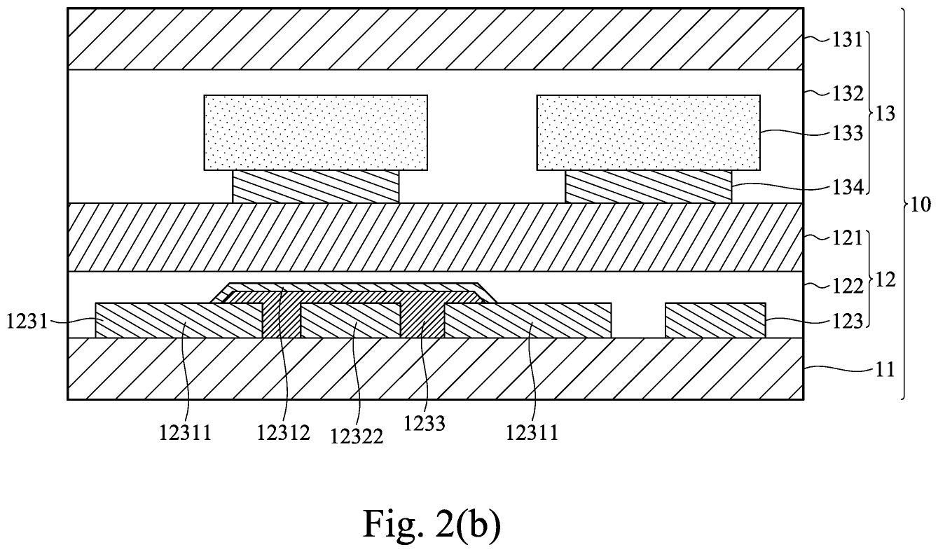

FIG. 2(a) shows a schematic diagram of a first preferred detailed structure corresponding to the first substrate 11, the first touch layer 12 and the display driver layer 13 in FIG. 1(a). In FIG. 2(a), a first touch layer 12 is configured on the first substrate 11, and the display driver layer 13 is configured on the first touch layer 12. The first touch layer 12 includes a planarization layer/overcoat layer (option) 121, a first insulation layer 122 and plural sensing electrodes 123. The plural sensing electrodes 123 include plural pairs of interlaced first sensing electrodes 1231 and second sensing electrodes 1232 (see FIG. 8(a)), each first sensing electrode 1231 includes plural first sensor pads 12311 and plural first connection parts 12312, and each second sensing electrode 1232 includes plural second sensor pads 12321 and plural second connection parts 12322 (see FIG. 8(a)). As shown in FIG. 2(a), a second insulation layer 1233 is configured between an intersection of the first connection part 12312 and the second connection part 12322. The display driver layer 13 includes an encapsulation layer 131, a third insulation layer 132, plural LEDs structure 133 and plural driver circuits 134, wherein the encapsulation layer 131 includes a gas barrier layer, the manufacturing method of the display driver layer 13 is to manufacture sequentially to form directly on the planarization layer 121 plural driver circuits 134, plural LEDs structure 133, the third insulation layer 132 and the encapsulation layer 131. Each LED 133 can be a Mini LED, a Micro LED, or an OLED. The OLED further includes an AMOLED, a PMOLED and a Super AMOLED. Certainly, the display driver layer 13 does not rule out using the LCD technology and the electronic paper technology. It is worth noting that in another preferred embodiment, the first touch layer 12 may not include the planarization layer 121, the first insulation 122 is combined directly with the planarization layer 121, and that is to say, the first insulation 122 has the function of planarization, and the plural driver circuits 134, the plural LEDs structure 133, the third insulation layer 132 and the encapsulation layer 131 are manufactured sequentially to form directly on the first insulation layer 122. It is worth mentioning that in another preferred embodiment, the display driver layer may not include the third insulation layer 132, and the encapsulation layer 131 and the third insulation layer 132 are combined together. In addition, the structure of the second touch layer 14 can include the structure such as the first touch layer 12 as shown in FIG. 2(a), and will not be repeated here.

FIG. 2(b) shows a schematic diagram of a second preferred detailed structure corresponding to the first substrate 11, the first touch layer 12 and the display driver layer 13 in FIG. 1(a). The differences between FIG. 2(b) and FIG. 2(a) are that between the two neighboring first sensor pads 12311, there is the first connection part 12312 that bridges the two neighboring first sensor pads 12311. A second insulation layer 1233 is further configured between an intersection of the first connection part 12312 and the second connection part 12322. In addition, the structure of the second touch layer 14 can include the structure such as the first touch layer 12 as shown in FIG. 2(a), and will not be repeated here.

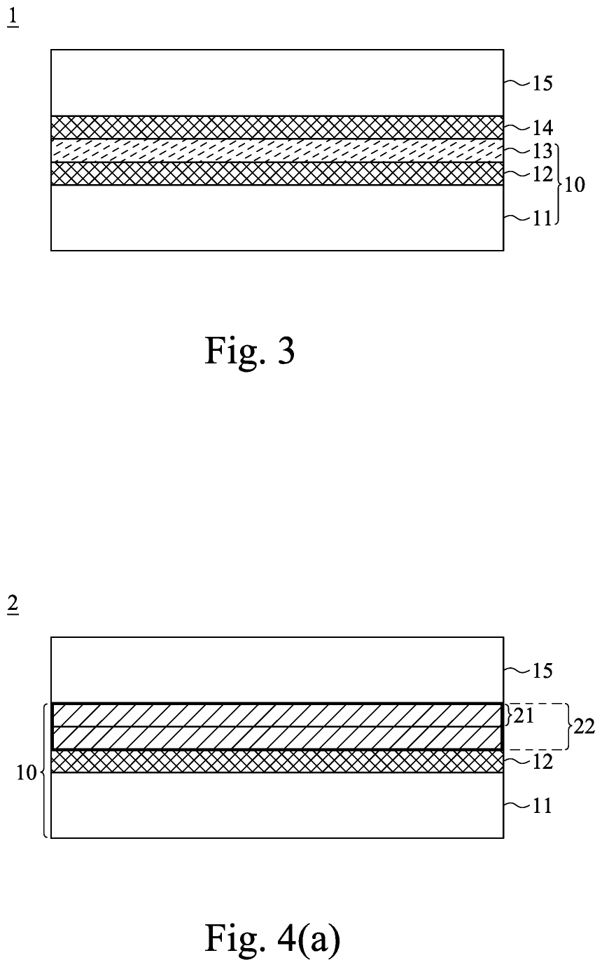

FIG. 3 shows a schematic structure diagram of a double-sided touch panel according to the first preferred embodiment of the present invention. As shown in FIG. 3, the double-sided touch panel 1 includes: a first substrate (cover plate) 11, a first touch layer 12 configured on the first substrate 11, a display driver layer 13 configured on the first touch layer 12, a second touch layer 14 configured on display driver layer 13, and a second substrate (cover plate) 15 configured on the second touch layer 14. In FIG. 3, the first substrate (cover plate) 11, the first touch layer 12 and the display driver layer 13 form a double-sided display 10.

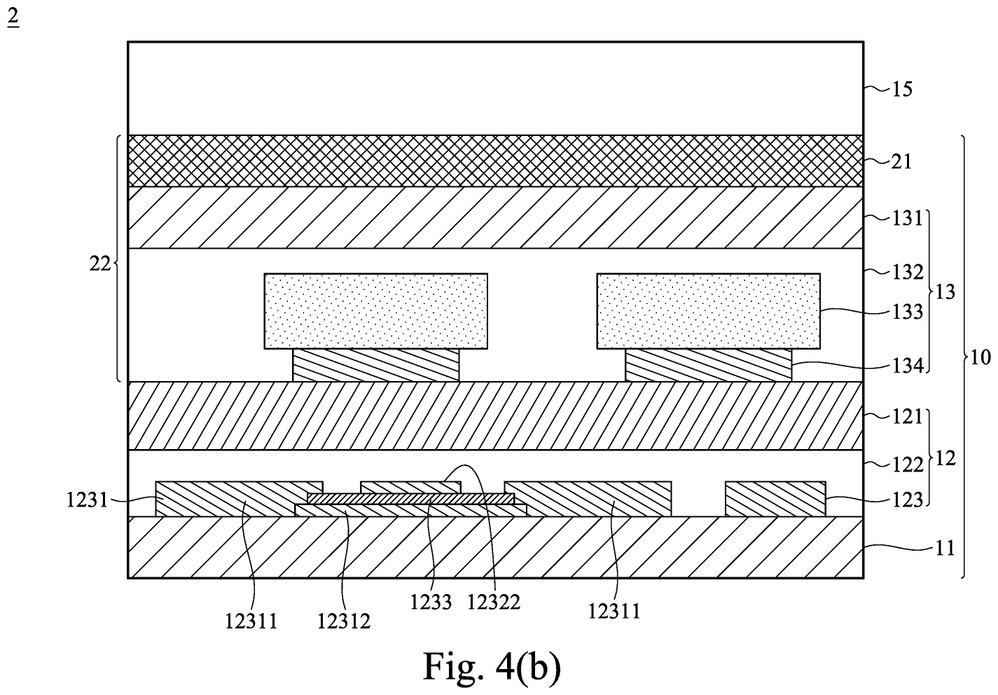

FIG. 4(a) shows a schematic structure diagram of a double-sided touch panel according to the second preferred embodiment of the present invention. In FIG. 4(a), the double-sided touch panel 2 includes: a first substrate (cover plate) 11, a first touch layer 12 configured on the first substrate 11, a display driver layer 22 including a second touch layer 21 and configured on the first touch layer 12, and a second substrate (cover plate) 15 configured on the display driver layer 22. As shown in FIG. 4(a), the double-sided touch panel 2 includes the double-sided display 10 (it includes the first substrate 11, the first touch layer 12, the display driver layer 22 including the second touch layer 21, and the second substrate (cover plate) 15, and the second touch layer 21 is embedded in the display driver layer 22 and configured on a main body 13 (as shown in FIG. 4(b)) of the display driver layer 22.

FIG. 4(b) shows a schematic structure diagram of a preferred detailed structure of a double-sided touch panel according to the second preferred embodiment of the present invention. The double-sided touch panel 2 includes the double-sided display 10 (it includes the first substrate 11, the first touch layer 12 and the display driver layer 22 including the second touch layer 21) and the second substrate (cover plate) 15. A method for manufacturing a double-sided touch panel 2 is listed as follows: a method of manufacturing a double-sided touch panel 2 comprises: providing a first substrate (cover plate) 11 and a second substrate (cover plate) 15; configuring a first touch layer 12 on the first substrate 11, wherein the first touch layer 12 includes a planarization layer/overcoat layer 121 (option), a first insulation layer 122 and plural sensing electrodes 123, and the plural sensing electrodes 123 include plural pairs of interlaced first sensing electrodes 1231 and second sensing electrodes 1232 (see FIG. 8(a)); configuring a main body 13 of a display driver layer 22 on the first touch layer 12, wherein the main body 13 (as shown in FIG. 4(b)) of the display driver layer 22 includes an encapsulation layer 131, a third insulation layer 132, plural LEDs structure 133 and plural driver circuits 134, wherein the encapsulation layer 131 includes a gas barrier layer, the double-sided display 10 further includes a second touch layer 21, wherein the second touch layer 21 has plural pairs of interlaced third sensing electrodes 141 and fourth sensing electrodes 142 (see FIG. 8(b)), directly configured on the encapsulation layer 131 and directly contacted with the encapsulation layer 131; and causing the second substrate 15 to be configured on the second touch layer 21, wherein the second substrate 15 may be connected to the second touch layer 21 via an adhesive layer (not shown). Similarly, the structure of the second touch layer 21 can include the structure such as the first touch layer 12, and will not be repeated here.

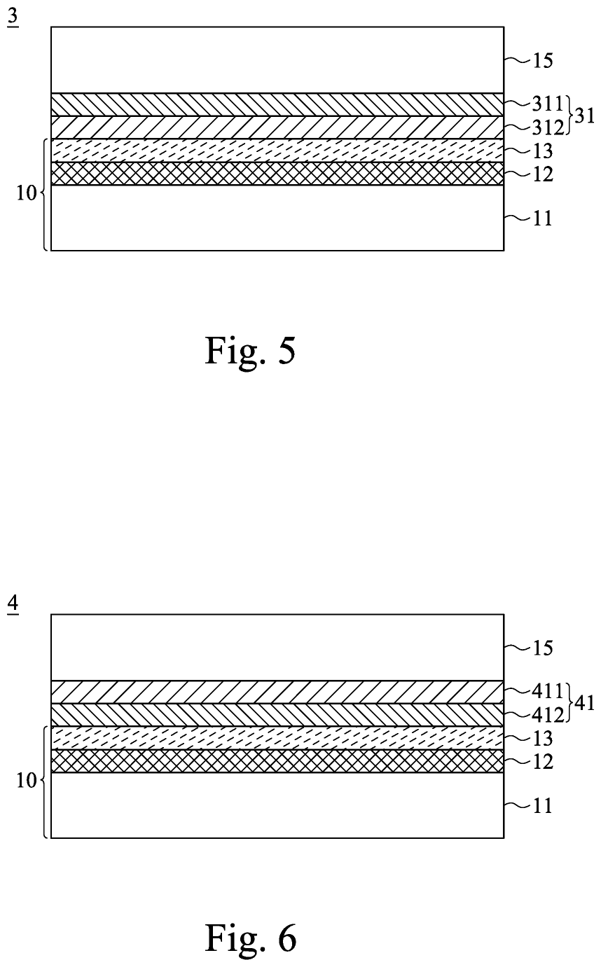

FIG. 5 shows a schematic structure diagram of a double-sided touch panel according to the third preferred embodiment of the present invention. In FIG. 5, the double-sided touch panel 3 includes: a first substrate (cover plate) 11, a first touch layer 12 configured on the first substrate 11, a display driver layer 13 configured on the first touch layer 12, a touch component 31 including a second touch layer 311 and a flexible substrate 312 and configured on the display driver layer 13, and a second substrate (cover plate) 15 configured on the touch component 31, wherein the material of the flexible substrate 312 can be, e.g., PET or polyimide (PI) etc.

FIG. 6 shows a schematic structure diagram of a double-sided touch panel according to the fourth preferred embodiment of the present invention. In FIG. 6, the double-sided touch panel 4 includes: a first substrate (cover plate) 11, a first touch layer 12 configured on the first substrate 11, a display driver layer 13 configured on the first touch layer 12, a touch component 41 including a flexible substrate 411 and a second touch layer 412 and configured on the display driver layer 13, and a second substrate (cover plate) 15 configured on the touch component 41, wherein the material of the flexible substrate 411 can be, e.g., PET or polyimide (PI) etc.

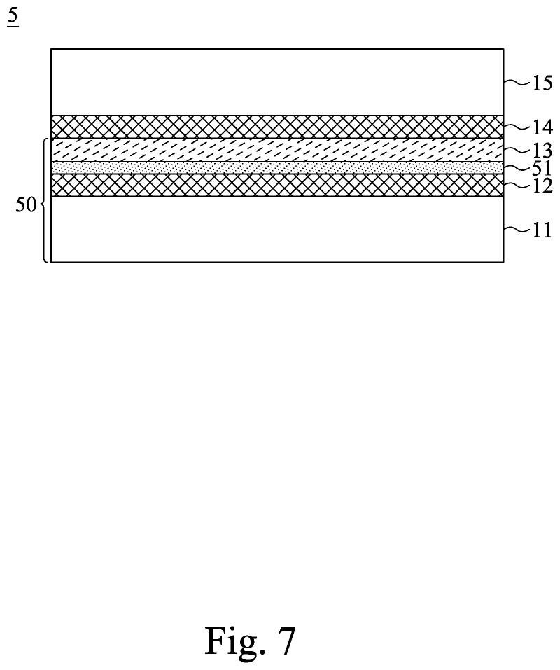

FIG. 7 shows a schematic structure diagram of a double-sided touch panel according to the fifth preferred embodiment of the present invention. As shown in FIG. 7, the double-sided touch panel 5 includes: a first substrate (cover plate) 11, a first touch layer 12 configured on the first substrate 11, a shielding layer 51 directly configured on the first touch layer 12, a display driver layer 13 configured on the shielding layer 51, a second touch layer 14 configured on the display driver layer 13, and a second substrate 15 configured on the second touch layer 14, wherein the material of the shielding layer 51 can be metal material or any conductive material to shield the electric signal of the display driver layer 13 such that the electric signal won't interfere with signals of the first touch layer 12. The first substrate (cover plate) 11, the first touch layer 12, the shielding layer 51 and the display driver layer 13 form a double-sided display 50. The main point of a method of manufacturing a double-sided touch panel of the present invention is to manufacture the first touch layer during the TFT manufacturing process. Thus, any different designs regarding the planarization layer or the shielding layer all belong to the scope of the double-sided touch panel proposed in the present invention. For example, between the shielding layer 51 and the display driver layer (display screen) 13 or between the shielding layer 51 and the first touch layer 12, a fourth insulation layer and a fifth insulation layer can be respectively configured (the fourth insulation layer and the fifth insulation layer are options).

FIG. 8(a) shows a schematic structure diagram of a first touch layer of a double-sided touch panel according to the first to the fifth preferred embodiments of the present invention. In FIG. 8(a), the first touch layer 12 includes plural pairs of interlaced first sensing electrodes 1231 and second sensing electrodes 1232. Each first sensing electrode 1231 includes plural first sensor pads 12311 and plural first connection parts 12312, each second sensing electrode 1232 includes plural second sensor pads 12321 and plural second connection parts 12322, wherein the first connection part 12312 connects two neighboring first sensor pads 12311 in series, and the second connection part 12322 connects two neighboring second sensor pads 12321 in series. The materials of the first sensing electrode 1231 and the second sensing electrode 1232 can be transparent conductive materials such as ITO, metal meshes, Graphene, or Nanosilver. An insulation layer 1233 is configured between an intersection of the first connection part 12312 and the second connection part 12322 (refer to FIG. 2(a)).

FIG. 8(b) shows a schematic structure diagram of a second touch layer of a double-sided touch panel according to the first to the fifth preferred embodiments of the present invention. As shown in FIG. 8(b), the second touch layer 14 includes plural pairs of interlaced third sensing electrodes 141 and fourth sensing electrodes 142. Each third sensing electrode 141 includes plural third sensor pads 1411 and plural third connection parts 1412, and each fourth sensing electrode 142 includes plural fourth sensor pads 1421 and plural fourth connection parts 1422, wherein the third connection part 1412 connects two neighboring third sensor pads 1411 in series, and the fourth connection part 1422 connects two neighboring fourth sensor pads 1421 in series. The materials of the third sensing electrode 141 and the fourth sensing electrode 142 can be transparent conductive materials such as ITO, metal meshes, Graphene, or Nanosilver. An insulation layer 1233 is configured between an intersection of the third connection part 1412 and the fourth connection part 1422 (refer to FIG. 2(b)).

According to the aforementioned descriptions, the present invention discloses a double-sided touch panel having a first touch layer with plural pairs of interlaced first sensing electrodes and second sensing electrodes and configured on a first substrate, a second touch layer with plural pairs of interlaced third sensing electrodes and fourth sensing electrodes and configured on a display screen or embedded in the display screen, and a second substrate. The first and the second substrates are transparent cover plates or translucent cover plates. The proposed manufacturing method of the double-sided touch panel manufactures the elements of the first touch layer at the same time when the display is manufactured to solve the existing problems of the follow-up bonding required by the double-sided touch panel and the overall thickness of the double-sided touch panel will be decreased. Thus, the proposed double-sided touch panel has non-obviousness and novelty.

While the invention has been described in terms of what is presently considered to be the most practical and preferred embodiments, it is to be understood that the invention need not be limited to the disclosed embodiments. Therefore, it is intended to cover various modifications and similar configurations included within the spirit and scope of the appended claims, which are to be accorded with the broadest interpretation so as to encompass all such modifications and similar structures.

1. A double-sided touch panel, comprising:
a first substrate;
a second substrate;
a first touch layer having plural pairs of interlaced first sensing electrodes and second sensing electrodes, and configured on the first substrate;
a display driver layer configured on the first touch layer; and
a second touch layer having plural pairs of interlaced third sensing electrodes and fourth sensing electrodes, and embedded in the display driver layer or configured between the display driver layer and the second substrate.

2. The double-sided touch panel according to claim 1, wherein:
the first and the second substrates are transparent cover plates or translucent cover plates;
when the display driver layer is a display screen, the second touch layer is configured on the display screen and the second substrate is configured on the second touch layer; and
when the display driver layer and the second touch layer form a display screen, the second touch layer is embedded in the display screen, and the second substrate is configured on the display screen.

3. The double-sided touch panel according to claim 1, wherein the first and the second touch layers include conductive metal meshes and/or transparent conducting materials, the first sensing electrodes include plural first sensor pads and plural first connection parts to plural fourth sensor pads and plural fourth connection parts, the second sensing electrodes include plural second sensor pads and plural second connection parts, the third sensing electrodes include plural third sensor pads and plural third connection parts, the fourth sensing electrodes include plural fourth sensor pads and plural fourth connection parts, the first to the fourth connection parts respectively connect the two neighboring first sensor pads in series to the two neighboring fourth sensor pads in series, the plural first sensor pads connected to one another in series and the plural first connection parts located on the same column form a respective one of the plural first sensing electrodes, the plural second sensor pads connected to one another in series and the plural second connection parts located on the same row form a respective one of the plural second sensing electrodes, the plural third sensor pads connected to one another in series and the plural third connection parts located on the same column form a respective one of the plural third sensing electrodes, and the plural fourth sensor pads connected to one another in series and the plural fourth connection parts located on the same row form a respective one of the plural fourth sensing electrodes.

4. The double-sided touch panel according to claim 1, further comprising a shielding layer, wherein the shielding layer is configured between the first touch layer and the display driver layer.

5. The double-sided touch panel according to claim 4, further comprising a first insulation layer and a second insulation layer, wherein the first insulation layer is configured between the display driver layer and the shielding layer, and the second insulation layer is configured between the shielding layer and the first touch layer.

6. A method of manufacturing a double-sided touch panel, comprising steps of:
(a) providing a first substrate;
(b) configuring a first touch layer on the first substrate, wherein the first touch layer has plural pairs of interlaced first sensing electrodes and second sensing electrodes;
(c) configuring a display driver layer to cause one side thereof to be adjacent to the first touch layer;
(d) providing a second substrate;
(e) configuring a second touch layer on the second substrate, wherein the second touch layer has plural pairs of interlaced third sensing electrodes and fourth sensing electrodes; and
(f) causing the other side of the display driver layer to be adjacent to the second touch layer so as to configure the second touch layer between the display driver layer and the second substrate, wherein a first group of the steps (a) to (c) and a second group of the steps (d) to (e) are performed simultaneously or sequentially.

7. The method according to claim 6, further comprising:
configuring a shielding layer between the first touch layer and the display driver layer.

8. The method according to claim 7, further comprising:
providing a first insulation layer and a second insulation layer;
configuring the first insulation layer between the display driver layer and the shielding layer; and
configuring the second insulation layer between the shielding layer and the first touch layer.

9. The method according to claim 6, further comprising:
when the display driver layer is a display screen, configuring the second touch layer between the display screen and the second substrate; and
when the display driver layer and the second touch layer form a display screen, causing the second touch layer to be embedded in the display screen, and causing the display screen to be configured between the second substrate and the first touch layer, wherein the first and the second substrates are transparent cover plates or translucent cover plates.

10. A method of manufacturing a double-sided touch panel, comprising:
providing a first substrate and a second substrate;
configuring a first touch layer on the first substrate, wherein the first touch layer has plural pairs of interlaced first sensing electrodes and second sensing electrodes;
configuring a display screen on the first touch layer; and
configuring a second touch layer between the display screen and the second substrate, or causing the second touch layer to be embedded in the display screen.

11. The method according to claim 10, further comprising:
causing the display screen to be combined with the second touch layer when the second touch layer is configured between the display screen and the second substrate, wherein the second touch layer has plural pairs of interlaced third sensing electrodes and fourth sensing electrodes.

12. The method according to claim 11, further comprising:
configuring a shielding layer between the first touch layer and the display screen.

13. The method according to claim 12, further comprising: providing a first insulation layer and a second insulation layer;
configuring the first insulation layer between the display screen and the shielding layer; and
configuring the second insulation layer between the shielding layer and the first touch layer.

14. The method according to claim 10, further comprising:
causing the second substrate to be configured on the display screen when the second touch layer is embedded in the display screen, wherein the second touch layer has plural pairs of interlaced third sensing electrodes and fourth sensing electrodes.
